(19) United States
(12) Patent Application Publication
(10) Pub. No.: US 2025/0236208 A1
(43) Pub. Date: Jul. 24, 2025

(54) Cryptocurrency Mining System For Electric Vehicle

(71) Applicant: Ga Ram PARK, Seoul (KR)

(72) Inventor: Ga Ram PARK, Seoul (KR)

(21) Appl. No.: 18/607,800

(22) Filed: Mar. 18, 2024

(30) Foreign Application Priority Data
Jan. 23, 2024 (KR) 10-2024-0009947

(51) Int. Cl. B60L 58/22; B60L 1/00; B60L 15/00; B60L 50/60; G06F 1/18; G06F 1/20

(52) U.S. Cl. CPC B60L 58/22; B60L 1/00; B60L 15/007; B60L 50/60; G06F 1/186; G06F 1/20; B60L 2210/30; B60L 2210/40

(57) ABSTRACT

Disclosed is a cryptocurrency mining system for an electric vehicle including: a vehicle-driving purpose battery configured to store therein power for driving an electric vehicle; a motor configured to rotate wheels of the vehicle using power stored in the vehicle-driving purpose battery; an electric generator configured to generate power using a rotational force of the wheels; a cryptocurrency-mining purpose battery configured to store therein the power generated by the electric generator; and a cryptocurrency mining device configured to mine cryptocurrency using the power stored in the cryptocurrency-mining purpose battery.

### CROSS-REFERENCE TO RELATED APPLICATION

This application claims priority to and the benefit of Korean Patent Application No. 2024-0009947, filed on Jan. 23, 2024, the disclosure of which is incorporated herein by reference in its entirety.

### BACKGROUND OF THE DISCLOSURE

### 1. Field of the Disclosure

The present disclosure relates to a cryptocurrency mining system, and more specifically, to a system for mining a cryptocurrency using an electric vehicle driven by a motor driven by electrical energy.

### 2. Description of the Related Art

Cryptocurrency (crypto money) refers to digital currency or electronic money used in an electronic form other than physical objects such as banknotes or coins in a networked virtual space.

Among the terms used herein, the cryptocurrency is sometimes referred to as virtual currency or encrypted currency. However, as used herein, it is collectively referred to as cryptocurrency.

Unlike real currency (coins, or banknotes) that is actually used, this cryptocurrency refers to intangible currency in a virtual environment. There are many types of such cryptocurrency, the representative one being ‘Bitcoin’, which was first developed in 2008. In addition, cryptocurrencies that are relatively actively traded include ‘Ripple’, ‘Ethereum’, and ‘Doji’. Cryptocurrencies other than Bitcoin are also called altcoins.

With credit cards and other simple payments, cash transactions are actually carried out by deducting a payment amount from the payment account deposited in the bank account and transferring the pay amount. However, when using the cryptocurrency, the user may buy and sell goods with just cryptocurrency without cash.

Cryptocurrency does not have a structure in which currency is issued and managed by a centralized institution, but rather has a structure in which transactions are made through a distributed database based on P2P (Peer to Peer).

Cryptocurrency such as Bitcoin automatically generates a certain amount of Bitcoin at regular intervals according to a set algorithm, and ownership of the generated cryptocurrency may be transferred by solving complex mathematical and cryptographic problems created through a specific algorithm.

Solving complex mathematical and cryptographic problems created through specific algorithms is referred to as cryptocurrency mining. Because the GPU installed on a graphics card has superior computing power than the CPU installed in the main mode of the computer, the cryptocurrency mining is done by graphics cards or multiple hash boards equipped with dedicated ASICs that perform only the calculations necessary for cryptocurrency mining.

Typical cryptocurrency mining operations are usually carried out in architectural structures, referred to as mining sites. In such a fixed cryptocurrency mining system, an additional cooling system or ventilation system should be built to cool the large amount of heat generated in a fixed location, and when effective heat dissipation is not achieved, there is a risk of fire. In addition, there is the problem of having to purchase a commercial power source to operate the mining system.

Thus, the inventor of the present disclosure has proposed a method to solve the above problem in the previous filed Korean Patent No. 2581047, “Cryptocurrency mining system for vehicle”. However, the inventor presents a new approach for a cryptocurrency mining system using a recently introduced electric vehicle that may be driven using electrical energy via the present application.

### PRIOR ART LITERATURE

### Patent Document

Patent Document 1: KR 10-2581047 B1
Patent Document 2: KR 10-2020-0024410 A
Patent Document 3: KR 10-1872286 B1

### SUMMARY OF THE DISCLOSURE

A purpose of one embodiment of the present disclosure is to provide a cryptocurrency mining system for an electric vehicle that may mine cryptocurrency using power generated from rotating wheels or drive shaft of the electric vehicle while the vehicle is driving.

Purposes according to the present disclosure are not limited to the above-mentioned purpose. Other purposes and advantages according to the present disclosure that are not mentioned may be understood based on following descriptions, and may be more clearly understood based on embodiments according to the present disclosure. Further, it will be easily understood that the purposes and advantages according to the present disclosure may be realized using means illustrated in the claims and combinations thereof.

One aspect of the present disclosure provides a cryptocurrency mining system for an electric vehicle comprising: a vehicle-driving purpose battery configured to store therein power for driving an electric vehicle; a motor configured to rotate wheels of the vehicle using power stored in the vehicle-driving purpose battery; an electric generator configured to generate power using a rotational force of the wheels; a cryptocurrency-mining purpose battery configured to store therein the power generated by the electric generator; and a cryptocurrency mining device configured to mine cryptocurrency using the power stored in the cryptocurrency-mining purpose battery.

In one embodiment of the cryptocurrency mining system for the electric vehicle, the cryptocurrency mining system further comprises: a first inverter configured to convert direct current power of the vehicle-driving purpose battery into alternating current power to be supplied to the motor; and a second inverter configured to convert direct current power of the cryptocurrency-mining purpose battery into alternating current power to be supplied to the cryptocurrency mining device.

In one embodiment of the cryptocurrency mining system for the electric vehicle, the electric generator is removed from or coupled to a drive shaft of the wheel, wherein the cryptocurrency mining system for the electric vehicle further comprises a controller configured to generate a control command to remove or couple the electric generator from or to the drive shaft, based on a rotation speed of the wheel or the drive shaft, wherein the controller is configured to remove the electric generator from the drive shaft when the electric vehicle is not traveling.

In one embodiment of the cryptocurrency mining system for the electric vehicle, the cryptocurrency mining system for the electric vehicle further comprises: a rectifier provided between and connected to the vehicle-driving purpose battery and the cryptocurrency-mining purpose battery, and configured to rectify a direction of current flow therebetween; and a switch provided between and connected to the vehicle-driving purpose battery and the cryptocurrency-mining purpose battery, and configured to control an electrical connection therebetween based on a control command from the controller.

In one embodiment of the cryptocurrency mining system for the electric vehicle, the controller is further configured to: when a remaining stored power amount of the cryptocurrency-mining purpose battery is smaller than or equal to a preset threshold and a remaining stored power amount of the vehicle-driving purpose battery is greater than or equal to a preset lower limit when the cryptocurrency mining device starts to operate or is operating, close the switch to charge the cryptocurrency-mining purpose battery with the power from the vehicle-driving purpose battery in response to a user input or a preset value.

In one embodiment of the cryptocurrency mining system for the electric vehicle, the cryptocurrency mining system for the electric vehicle further comprises: a slot unit defined in the vehicle and having a predetermined space; a slot door provided at an outer surface of the electric vehicle to close or open the slot unit; and at least one slot located in the slot unit, and connected to the cryptocurrency mining device, wherein a graphics card is removably mounted into the slot.

In one embodiment of the cryptocurrency mining system for the electric vehicle, the controller is further configured to: identify a power consumption of each graphics card mounted into each of the at least one slot; and select and operate the graphics card to be used by the cryptocurrency mining device based on a remaining stored power amount of the cryptocurrency-mining purpose battery.

In one embodiment of the cryptocurrency mining system for the electric vehicle, the controller is further configured to: when the remaining stored power amount of the cryptocurrency-mining purpose battery is smaller than a total of power consumptions of currently installed graphics cards into the slots, select and operate a graphics card with a lowest power consumption among the graphics cards respectively installed into the plurality of slots at a highest priority.

In one embodiment of the cryptocurrency mining system for the electric vehicle, the controller is further configured to: identify a power consumption of each graphics card mounted into each of the at least one slot; and determine a graphics card with the power consumption of 0 as a faulty graphics card.

In one embodiment of the cryptocurrency mining system for the electric vehicle, the slot door includes a shock-absorbing member protruding from an inner surface thereof toward the slot, wherein when the slot door is closed, the shock-absorbing member presses the graphics card mounted into the slot to prevent the graphics card from being removed from the slot.

In one embodiment of the cryptocurrency mining system for the electric vehicle, the cryptocurrency mining system for the electric vehicle further comprises: a first temperature sensor for measuring a temperature within the slot unit; a second temperature sensor for measuring a temperature within a cryptocurrency-mining purpose battery storage space in which the cryptocurrency-mining purpose battery is received; a first duct constructed to direct heat generated from the graphics card to the cryptocurrency-mining purpose battery storage space; and a second duct constructed to direct air within the cryptocurrency-mining purpose battery storage space to the slot unit, wherein the controller is further configured to: when a temperature measured by the first temperature sensor is higher than a preset first threshold temperature, and a temperature measured by the second temperature sensor is lower than a preset second threshold temperature, direct the air in the slot unit to the cryptocurrency-mining purpose battery storage space through the first duct, and direct the air in the cryptocurrency-mining purpose battery storage space to the slot unit through the second duct.

The cryptocurrency mining system for an electric vehicle according to the present disclosure may mine cryptocurrency using the power generated from the rotating wheels or drive shaft when the electric vehicle is driving.

Moreover, the user may conveniently selectively install and remove the graphics card as needed. During mining, the heat generated from the graphics card may be used to control the vehicle's interior temperature, or conversely, the vehicle's interior temperature may be used to cool the graphics card.

Effects of the present disclosure are not limited to the effects mentioned above, and other effects not mentioned will be clearly understood by those skilled in the art from the descriptions below.

### BRIEF DESCRIPTION OF THE DRAWINGS

Further aspects, features and benefits as described above of certain preferred embodiments of the present disclosure will become more apparent from the following description taken in conjunction with the accompanying drawings.

FIG. 1 is a schematic diagram of a cryptocurrency mining system for an electric vehicle according to one embodiment of the present disclosure.

FIG. 2 is a connection diagram between a cryptocurrency-mining purpose battery and a vehicle-driving purpose battery of the cryptocurrency mining system for an electric vehicle according to one embodiment of the present disclosure.

FIG. 3 is a step-by-step flowchart of an operation process between the cryptocurrency-mining purpose battery and the vehicle-driving purpose battery of the cryptocurrency mining system for an electric vehicle according to one embodiment of the present disclosure.

FIG. 4 is a diagram showing a slot unit of the cryptocurrency mining system for an electric vehicle according to one embodiment of the present disclosure.

FIG. 5 is a step-by-step flowchart of a process of operating a graphics card based on a priority in the cryptocurrency mining system for an electric vehicle according to one embodiment of the present disclosure.

FIG. 6 is a step-by-step flowchart of a process of determining a failure of a graphics card in the cryptocurrency mining system for an electric vehicle according to one embodiment of the present disclosure.

FIG. 7 is a duct connection diagram between the slot unit and the cryptocurrency-mining purpose battery storage space in the cryptocurrency mining system for an electric vehicle according to one embodiment of the present disclosure.

### DETAILED DESCRIPTION OF THE DISCLOSURE

Hereinafter, embodiments disclosed in the present specification will be described in detail with reference to the attached drawings, but identical or similar components will be assigned the same reference numbers regardless of drawing symbols, and duplicate descriptions thereof will be omitted. The suffixes “unit” and “part” for components used in the description below are given only for the ease of writing the specification, or are used interchangeably with each other and do not have distinct meanings or roles in themselves. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure. Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “connected to”, or “connected to” another element or layer, it may be directly on, connected to, or connected to the other element or layer, or one or more intervening elements or layers may be present. In addition, it will also be understood that when an element or layer is referred to as being “between” two elements or layers, it may be the only element or layer between the two elements or layers, or one or more intervening elements or layers may also be present.

The terminology used herein is directed to the purpose of describing particular embodiments only and is not intended to be limiting of the present disclosure.

As used herein, the singular constitutes “a” and “an” are intended to include the plural constitutes as well, unless the context clearly indicates otherwise.

It will be further understood that the terms “comprise”, “comprising”, “include”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of associated listed items.

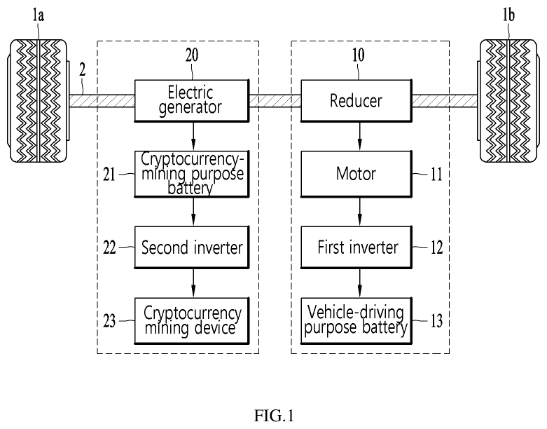

FIG. 1 is a schematic diagram of a cryptocurrency mining system for an electric vehicle according to one embodiment of the present disclosure.

As shown in FIG. 1, the cryptocurrency mining system for an electric vehicle according to one embodiment of the present disclosure may include a vehicle-driving purpose battery 13 that stores therein power for driving the electric vehicle, a motor 11 that rotates a wheel using the power stored in the a vehicle-driving purpose battery 13, an electric generator 20 that generates power using a rotational force of the wheel, a cryptocurrency-mining purpose battery 21 that stores therein the power generated by the electric generator 20, and a cryptocurrency mining device 23 that mines the cryptocurrency using the power stored in the cryptocurrency-mining purpose battery 21.

The electric vehicle does not have an internal combustion engine such as an engine, but uses the power stored in the vehicle-driving purpose battery 13 to drive the motor 11 and rotate wheels 1a and 1b coupled to a drive shaft 2. In this way, the vehicle may drive.

The motor 11 may convert electrical energy into kinetic energy to rotate the wheels 1a and 1b. A reducer 10 may refer to a gear or a transmission that efficiently transmits the power of the motor 11 to the drive shaft 2 or the wheels 1a and 1b, and may be configured to reduce revolutions per minute of the motor 11 to obtain a high torque.

The vehicle-driving purpose battery 13 is a device that stores therein electrical energy, and the motor 11 may be driven using the power stored in the vehicle-driving purpose battery 13.

A first inverter 12 may be provided between the vehicle-driving purpose battery 13 and the motor 11. The first inverter 12 may be configured to convert direct current power output from the vehicle-driving purpose battery 13 into alternating current power which may be supplied to the motor 11. The first inverter 12 may adjust a frequency of the AC power applied to the motor 11 according to a control command of a controller to increase or decrease a driving speed of the motor 11.

Charging and discharging of the vehicle-driving purpose battery 13 may be controlled by a battery management system (BMS) within the electric vehicle. In addition, the electric vehicle may further include a voltage conversion device to convert a high voltage power output from the vehicle-driving purpose battery 13 to a low voltage of 12V or 24V as the commercial power voltage for various electronic devices in the electric vehicle.

Moreover, the cryptocurrency mining device 23 according to one embodiment of the present disclosure refers to a device capable of mining the cryptocurrency by performing computational functions, and may be embodied as a computing device including at least one graphics card or hash board (collectively referred to as “graphics card” as used herein).

In order for the cryptocurrency mining device 23 to perform calculation functions and solve complex mathematical or cryptographic problems, the power should be supplied thereto from an external source. Thus, according to one embodiment of the present disclosure, a driving power of the cryptocurrency mining device 23 may be the power stored in the cryptocurrency-mining purpose battery 21.

The cryptocurrency-mining purpose battery 21 refers to a device that stores therein electrical energy in a similar manner to the vehicle-driving purpose battery 13, and allows the cryptocurrency mining device 23 to mine the cryptocurrency using the power stored in the cryptocurrency-mining purpose battery 21.

The cryptocurrency-mining purpose battery 21 and the vehicle-driving purpose battery 13 may be physically removed from each other, and in this case, charging schemes and discharging targets as well as input and output voltages/currents of the cryptocurrency-mining purpose battery 21 and the vehicle-driving purpose battery 13 may be different from each other.

According to one specific embodiment, the vehicle-driving purpose battery 13 may be charged upon receiving power from a commercial power source external to the electric vehicle. The cryptocurrency-mining purpose battery 21 may store therein at least a portion of the power generated by the electric generator 20 provided at the drive shaft 2 to which the wheels 1a and 1b are coupled.

In other words, the cryptocurrency mining device 23 may receive the power generated from the electric generator 12 under the driving of the electric vehicle and perform a mining task of mining the cryptocurrency using the power stored in the cryptocurrency-mining purpose battery 21.

However, the power supplied to a power supply (for example, SMPS; switched mode power supply) of the cryptocurrency mining device 23 is alternating current power, and the power output from the cryptocurrency-mining purpose battery 21 is direct current power. Thus, in order to convert the DC power output from the cryptocurrency-mining purpose battery 21 into sinusoidal AC power and provide the converted power to the cryptocurrency mining device 23, a second inverter 22 may be installed between the cryptocurrency-mining purpose battery 21 and the cryptocurrency mining device 23.

In this regard, in order to for the second inverter 22 to apply stable power to the cryptocurrency mining device 23, the second inverter 22 may output 220V at 50/60 Hz as the commercial power supply of the cryptocurrency mining device 23 in a constant manner, which is not case for the first inverter 12.

As described above, the electric generator 20 according to one embodiment of the present disclosure may be coupled to the drive shaft 2 to generate electricity. In another example, according to one preferred embodiment of the present disclosure, the electric generator 20 and the drive shaft 2 are not directly connected to each other, but are coupled to each other via a clutch, so that the electric generator 20 and the drive shaft 2 are connected to each other or separated from each other according to the control command of the controller.

The clutch may be coupled to the drive shaft 2 and a rotor of the electric generator 20, and this clutch may control the connection between the drive shaft 2 and the electric generator 20 according to the control command of the controller.

In one example, according to one embodiment of the present disclosure, a cryptocurrency mining system for an electric vehicle including the cryptocurrency mining device 23 may include the controller as a means to control overall operations thereof.

The controller may be configured to execute various applications and perform related operations in conjunction with each of the components of the cryptocurrency mining system for an electric vehicle, especially the cryptocurrency mining device 23, the second inverter 22, and the clutch. In other words, the controller may be configured to perform cryptocurrency mining operations using the electric vehicle by processing signals or data input and output through the components of the cryptocurrency mining system for the electric vehicle, or by executing the application programs stored in a storage.

In other words, the controller may be configured to operate the cryptocurrency mining device 23 according to a user input through an interface device or a series of operation processes composed of predetermined steps stored in the storage to mine the cryptocurrency.

Moreover, as described above, the controller may be configured to generate the control command to regulate the connection between the drive shaft 2 and the electric generator 20, and to transmit the control command generated in this way to the clutch so that the drive shaft 2 and the electric generator 20 are coupled to or removed from each other via the clutch.

However, the electric generator 20 according to one embodiment of the present disclosure may be coupled to the drive shaft 2. Thus, when the drive shaft 2 starts rotating, the rotor of the electric generator 20 may interfere with the rotational movement of the drive shaft 2 due to inertia thereof. This may ultimately affect the battery consumption of the vehicle-driving purpose battery 13. For this reason, it is desirable that the electric generator 20 according to one embodiment of the present disclosure is capable of being coupled to and separated from the drive shaft 2.

Accordingly, the controller may be configured to measure or identify a current speed of the electric vehicle or a current rotational speed of the wheels 1a and 1b or the drive shaft 2. When the electric vehicle, the wheels 1a and 1b or the drive shaft 2 are at a stop state or changes from the stop state to a movement starting state, the controller may separate the electric generator 20 from the drive shaft 2.

When the electric vehicle is running such that the electric vehicle, the wheels 1a and 1b, or the drive shaft 2 are moving at a predetermined speed or higher, the controller may couple the electric generator 20 to the drive shaft 2.

In a specific example, the controller may be configured to measure or receive the current speed of the electric vehicle. When the current speed of the electric vehicle is 0 or lower than a preset operating reference speed, the controller may remove the electric generator 20 from the drive shaft 2 using the clutch. When the current speed of the traveling electric vehicle exceeds the operating reference speed, the controller may couple the electric generator 20 to the drive shaft 2 using the clutch.

In this way, the coupling of the electric generator 20 to the drive shaft 2 may be controlled according to the control command of the controller, so that the power consumption of the vehicle-driving purpose battery 13 may be minimized.

The electric generator 20 coupled to the drive shaft 2 may generate the power and store the same in the cryptocurrency-mining purpose battery 21. After a predetermined level of power has been stored in the cryptocurrency-mining purpose battery 21, the cryptocurrency mining device 23 may perform a cryptocurrency mining operation using the power stored in the cryptocurrency-mining purpose battery 21 even when the electric vehicle does not drive.

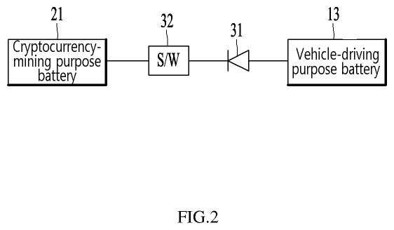

In one example, FIG. 2 is a connection diagram between the cryptocurrency-mining purpose battery and the vehicle-driving purpose battery of a cryptocurrency mining system for an electric vehicle according to one embodiment of the present disclosure.

As shown in FIG. 2, the cryptocurrency-mining purpose battery 21 according to one embodiment of the present disclosure may be electrically connected to the vehicle-driving purpose battery 13. The controller may be configured to control an operation of a switch 32 such that the power stored in the vehicle-driving purpose battery 13 is transmitted to and stored in the cryptocurrency-mining purpose battery 21.

For this purpose, a rectifier 31 may be installed between the cryptocurrency-mining purpose battery 21 and the vehicle-driving purpose battery 13 to allow the current to flow in only one direction from the vehicle-driving purpose battery 13 to the cryptocurrency-mining purpose battery 21. Further, the switch 32 that may be configured to control the electrical connection between the cryptocurrency-mining purpose battery 21 and the vehicle-driving purpose battery 13 according to the control command of the controller may be installed between the cryptocurrency-mining purpose battery 21 and the vehicle-driving purpose battery 13.

In order that the stored power in the vehicle-driving purpose battery 13 is charged to the cryptocurrency-mining purpose battery 21, a power conversion element unit (not shown) for converting an input/output voltage and/or current may be installed on a connection line between the vehicle-driving purpose battery 13 and the cryptocurrency-mining purpose battery 21. A battery charge and discharge control device (not shown) may be provided to control charged and discharged states when charging the cryptocurrency-mining purpose battery 21 using the power stored in the vehicle-driving purpose battery 13.

Hereinafter, a process of charging the power stored in the vehicle-driving purpose battery 13 to the cryptocurrency-mining purpose battery 21 according to one embodiment of the present disclosure will be described.

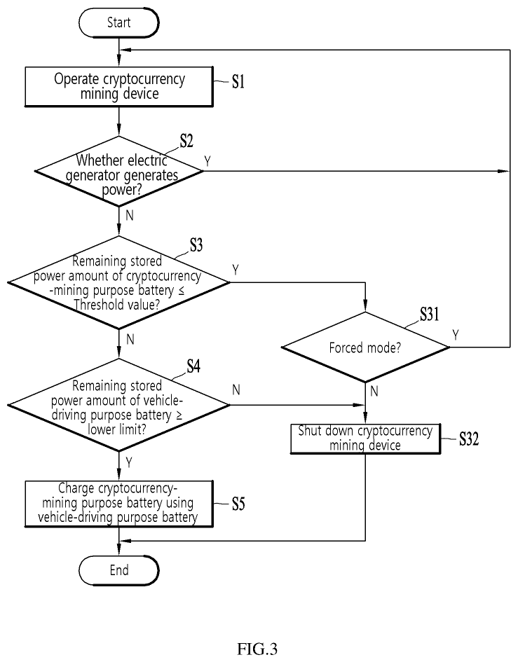

FIG. 3 is a step-by-step flowchart of an operation process between the cryptocurrency-mining purpose battery and the vehicle-driving purpose battery of the cryptocurrency mining system for an electric vehicle according to one embodiment of the present disclosure.

As shown in FIG. 3, the controller according to one embodiment of the present disclosure may be configured to identify whether power is generated from the electric generator 20 S2 when the cryptocurrency mining device 23 is started or is operating in S1. In this regard, when the electric generator 20 does not operate normally and generate power, but operates in an abnormal state such that power is not generated by the electric generator 20, or an amount of power as generated (or an amount of power per hour) does not reach a preset lower limit, and further when the remaining stored power of the cryptocurrency-mining purpose battery 21 is below a preset threshold in S3 and the remaining stored power of the vehicle-driving purpose battery 13 is above the preset lower limit in S4, the cryptocurrency-mining purpose battery 21 may be charged with the power of the vehicle-driving purpose battery 13.

In other words, when the electric generator 20 is not operating normally, and further when the power stored in the vehicle-driving purpose battery 13 is above the lower limit for minimum or normal driving in S4, but the power stored in the cryptocurrency-mining purpose battery 21 is below the threshold in S3, so that it is difficult to operate the cryptocurrency mining device 23 normally, the cryptocurrency-mining purpose battery 21 may be charged using the power stored in the vehicle-driving purpose battery 13.

In order to charge the power stored in the vehicle-driving purpose battery 13 into the cryptocurrency-mining purpose battery 21, the switch 32 provided between the vehicle-driving purpose battery 13 and the cryptocurrency-mining purpose battery 21 may be closed. When necessary, the battery charge and discharge control device may be used to control battery charge and discharge between the vehicle-driving purpose battery 13 and the cryptocurrency-mining purpose battery 21, thereby transferring the power stored in the vehicle-driving purpose battery 13 to the cryptocurrency-mining purpose battery 21 to charge the cryptocurrency-mining purpose battery 21.

If the electric generator 20 is not operating normally, but the remaining stored power of the cryptocurrency-mining purpose battery 21 exceeds the preset threshold, the controller may be configured to allow the cryptocurrency mining device 23 to perform a safe shutdown operation using the remaining power in the cryptocurrency-mining purpose battery 21 in S32. However, the controller may be configured to operate in a forced mode due to user input, etc. in S31. When the forced mode is activated, the controller may be configured to allow the cryptocurrency mining device 23 to continue to perform the cryptocurrency mining operation using the remaining power in the cryptocurrency-mining purpose battery 21 in S1 without shutting down the cryptocurrency mining device 23.

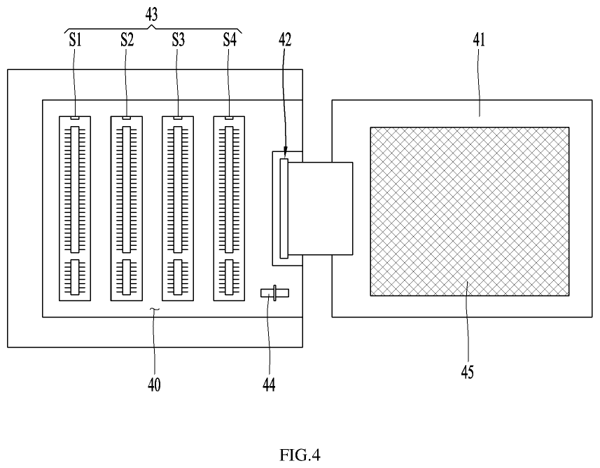

In one example, FIG. 4 is a diagram showing a slot unit of a cryptocurrency mining system for an electric vehicle according to one embodiment of the present disclosure.

As shown in FIG. 4, the cryptocurrency mining system for an electric vehicle according to one embodiment of the present disclosure may include a slot unit 40 having a predefined space defined in one surface of the electric vehicle, and a slot door 41 for opening and closing the slot unit.

The slot door 41 pivotally installed at an outer surface of the electric vehicle may open and close the slot unit 40 having the predetermined space. Accordingly, when the slot door 41 is opened, the slot unit 40 may be exposed to the outside. Conversely, when the slot door 41 is closed, the slot unit 40 may not be exposed to the outside.

The slot unit 40 having the predetermined space may be closed or opened by the slot door 41. The slot unit 40 includes at least one slot S1 to S4 43 where the graphics card may be removably installed, so that the user may open the slot door 41 and conveniently insert and install the graphics card into the slot 43.

The slot 43 provided in the slot unit 40 may be electrically connected to the cryptocurrency mining device 23, and the cryptocurrency mining device 23 may identify whether the graphics card is installed into the slot 43 using a plug-and-play function, etc. Additionally, the cryptocurrency mining device 23 may perform cryptocurrency mining operations using the graphics card installed in the slot 43.

In this regard, the slot unit 40 may include a plurality of slots 43. However, the present disclosure is not specifically limited thereto. When the graphics cards are installed into the plurality of slots 43 by the user, the cryptocurrency mining device 23 may perform the cryptocurrency mining operations using the graphics cards.

The slot unit 40 including the slot 43 according to one embodiment of the present disclosure may be provided adjacent to an outside surface of the electric vehicle in a similar manner to a charging terminal for charging the vehicle-driving purpose battery 13 in the electric vehicle. Thus, it is desirable to ensure that heat generated from the graphics card due to the cryptocurrency mining operations may be easily cooled.

However, since the slot 43 is defined in the electric vehicle, the graphics card mounted into the slot 43 may be removed from the slot 43 due to vibration or shock when the electric vehicle is driving.

Therefore, in order to solve this problem, the slot door 41 according to one embodiment of the present disclosure may include a shock-absorbing member 45 formed on an inner surface thereof and protruding therefrom toward the slot 43, more specifically, the graphics card mounted into the slot 43.

The shock-absorbing member 45 may be embodied as an elastic member having a predetermined height. When the slot door 41 is closed, the shock-absorbing member 45 may pressurize the graphics card mounted into the slot 43, thereby preventing the graphics card from being removed from the slot 43 due to vibration or shock while the electric vehicle is running.

In other words, the slot unit 40 disposed inwardly of the slot door 41 may be a space of a predetermined size so that the graphics card may be installed in at least one of the slots 43. When the slot door 41 is closed, an anti-static sheet provided on an inner surface of the slot door 41 may press the graphics card mounted into the slot 43 toward the slot 43.

The shock-absorbing member 45 may be made of an elastic material which may be elastically displaced in at least the thickness direction thereof. Thus, when the slot door 41 is closed, the shock-absorbing member 45 may contact the graphics card with electronic components and pressurize the graphics card. Thus, the shock-absorbing member 45 according to one preferred embodiment may act as the anti-static sheet so as not to generate static electricity and to prevent leakage current from the graphics card from being applied to another graphics card.

The anti-static sheet may be made of a material that does not transmit electricity, and may prevent a substrate of the graphics card from being electrically charged, that is, may prevent the graphics card in the slot unit 40 from being electrically shocked.

A reference numeral 42 in FIG. 4 may refer to a hinge shaft provided to allow the slot door 41 to be opened and closed. The slot unit 40 into which the graphics card is mounted is provided adjacent to an outer side surface of the electric vehicle so that the graphics card in a heat-generating state may be easily cooled.

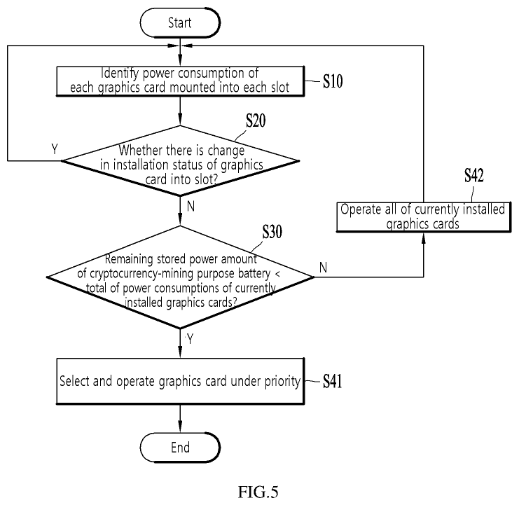

In one example, FIG. 5 is a step-by-step flowchart of a process of operating a graphics card based on a priority in a cryptocurrency mining system for an electric vehicle according to one embodiment of the present disclosure.

As shown in FIG. 5, a plurality of slots 43 may be provided in the slot unit 40 according to one embodiment of the present disclosure. When the graphics card is installed in each of at least some of the plurality of slots 43 by the user, the controller may be configured to identify a power consumption of each of the graphics cards respectively installed in the plurality of slots 43 in S10.

In this regard, the controller may identify the power consumption of each of the graphics cards respectively installed in the plurality of slots 43, compare the power consumption with the remaining stored power of the cryptocurrency-mining purpose battery 21 in S30, and then select at least some of the graphics cards to be used by the cryptocurrency mining device 23 during cryptocurrency mining based on the comparing result, and operate the selected one(s) in S41 to S42.

According to one specific embodiment, the controller may be configured to identify a total of the power consumptions of currently installed graphics cards in S10 and then compare the same with the remaining stored power of the current cryptocurrency-mining purpose battery 21 in S30. Then, when the remaining storage power of the cryptocurrency-mining purpose battery 21 is smaller than the total of the power consumptions of the graphics cards, the controller may be configured to select and operate a graphics card with low power consumption at the highest priority among the graphics cards in S41.

That is, the stored power of the cryptocurrency-mining purpose battery 21 may be charged under the operation of the electric generator 20 or with the power stored in the vehicle-driving purpose battery 13 in the forced mode. When the cryptocurrency-mining purpose battery 21 is not fully charged, one or two or more of the graphics cards may be selected in an order opposite to an order of the power consumption, depending on the remaining power stored in the current cryptocurrency-mining purpose battery 21. In this regard, it is preferable that the sum of the power consumptions of the selected graphics cards is smaller than the remaining stored power of the current cryptocurrency-mining purpose battery 21. As the charged amount of the cryptocurrency-mining purpose battery 21 gradually increases, at least some of the remaining graphics cards which are currently inactive may be selected in an order opposite to an order of the power consumption and then the selected ones may be activated.

Conversely, the remaining stored power of the current cryptocurrency-mining purpose battery 21 may be greater than the sum of the power consumptions of the currently installed graphics cards. At this time, the controller may control the cryptocurrency mining device 23 to perform the cryptocurrency mining operation using all of the currently installed graphics cards.

In one example, the controller according to one embodiment of the present disclosure may identify the power consumption of the graphics card installed into each of the slots 43 of the slot unit 40 S10 and store the identified power consumption in the storage. Usually, the graphics card may be installed into or removed from the slot 43 of the slot unit 40 infrequently. Thus, using the plug-and-play function, the controller may identify whether there is a change in an installation status of the graphics card into the slot 43 in S20. When there is no change in the installation status of the graphics card into the slot, the controller may be configured to compare the power consumption of the graphics card corresponding to each slot pre-stored in the storage with the remaining stored power of the cryptocurrency-mining purpose battery 21 in S30 and may select and operate at least some among the plurality of graphics cards based on the comparing result in S41.

When the controller uses the power consumption value of the graphics card corresponding to each slot pre-stored in the storage, there is no need to frequently identify the power consumption of the graphics card corresponding to each slot at regular intervals or in real time.

When there is a change in the installation state of the graphics card into the slot 43, the controller may be configured to re-identify the power consumption of the graphics card mounted into each slot 43 in S10 and may store the re-identified power consumption in the storage to update the data therein.

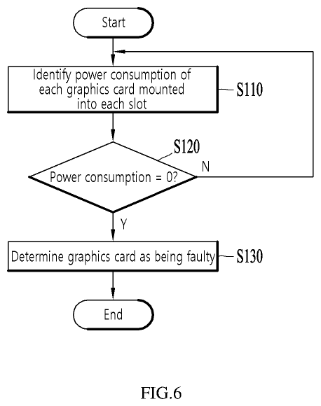

In one example, FIG. 6 is a step-by-step flowchart of a process of determining a failure of a graphics card in a cryptocurrency mining system for an electric vehicle according to one embodiment of the present disclosure.

As shown in FIG. 6, the controller according to one embodiment of the present disclosure may be configured to identify the power consumption of each graphics card mounted into each of the plurality of slots 43 of the slot unit 40 in S110. When, based on the identifying result of the power consumption of each graphics card in S110, the power consumption thereof is 0 in S120, the controller may be configured to determine a failure of the corresponding graphics card in S130.

Therefore, even when the graphics card is installed into at least one of the plurality of slots 43 of the slot unit 40, the controller may determine that the graphics card is faulty when the power consumption of the graphics card is 0. The determination result may be notified to the user in a visual or auditory form through an alarm device or external terminal. The controller may prevent the cryptocurrency mining device 23 from performing the cryptocurrency mining operations or repeating attempts at mining operations using the graphics card in a faulty state.

When at least one graphics card is installed in the slot unit 40 and the cryptocurrency mining device 23 mines cryptocurrency using the graphics card installed into the slot unit 40, a temperature around the slot unit 40 or the graphics card may rise due to heat generation from the graphics card. The graphics card in a high temperature state may not only reduce the effectiveness of the cryptocurrency mining, but also shorten the lifespan of the graphics card.

To solve this problem, a temperature sensor 44 may be provided within the slot unit 40 to measure the temperature around the graphics card mounted into the slot 43 (see FIG. 4). Moreover, a temperature sensor (not shown) that measures a temperature may be provided in a storage space 3 where the cryptocurrency-mining purpose battery 21 is accommodated as will be described later.

When the temperature value measured by the temperature sensor 44 provided in the slot unit 40 is higher than a preset threshold temperature, the controller may direct high temperature air within the slot unit 40 to the cryptocurrency-mining purpose battery 21 through a duct.

Due to low temperature, especially in winter, the cryptocurrency-mining purpose battery 21 has a lowered charging amount and a charging speed thereof slows down, resulting in low charging efficiency. Thus, a high-temperature air is generated within the slot unit 40 due to the operation of the graphics card, and then, the high-temperature air within the slot unit 40 is applied to the cryptocurrency-mining purpose battery 21, specifically, the storage space 3 containing the cryptocurrency-mining purpose battery 21 therein, thereby increasing the charging efficiency of the cryptocurrency-mining purpose battery 21.

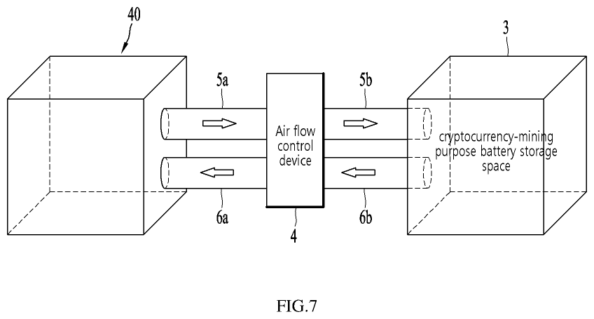

FIG. 7 is a duct connection diagram between the slot unit and the cryptocurrency-mining purpose battery storage space of the cryptocurrency mining system for an electric vehicle according to one embodiment of the present disclosure.

As shown in FIG. 7, the duct may be provided between the slot unit 40 and the storage space 3 where the cryptocurrency-mining purpose battery 21 is accommodated and may act as a flow path through which air may flow therebetween. In this regard, according to one preferred embodiment, the duct may include a plurality of ducts, such as a first duct 5a and 5b and a second duct 6a and 6b.

Accordingly, when the temperature in the slot unit 40 is higher than a preset first threshold temperature, and the temperature in the storage space 3 is lower than a preset second threshold temperature, the controller may direct the high-temperature air in the slot unit 40 to the cryptocurrency-mining purpose battery 21 through the first duct 5a and 5b. In conjunction with this directing, the controller may direct the low-temperature air in the storage space 3 to the slot unit 40 via the second duct 6a and 6b. In this regard, the first threshold temperature and the second threshold temperature are different from each other, wherein the first threshold temperature may be higher than the second threshold temperature.

In this regard, as used herein, for easy description of the present disclosure, the first duct 5a and 5b may refer to a passage through which air flows from the slot unit 40 to the storage space 3 where the cryptocurrency-mining purpose battery 21 is accommodated. The second duct 6a and 6b may refer to a passage through which air flows from the storage space 3 where the cryptocurrency-mining purpose battery 21 is accommodated to the slot unit 40. However, the present disclosure is not specifically limited thereto.

According to one preferred embodiment of the present disclosure, the high temperature air in the slot unit 40 may be guided to the storage space 3 along the first duct 5a and 5b. The low-temperature air in the storage space 3 is guided back to the slot unit 40 along the second duct 6a and 6b, so that the air circulates.

An air flow control device 4 may be disposed on the first duct 5a and 5b and the second duct 6a and 6b and may be configured to allow the air to flow smoothly along the first duct 5a and 5b and the second duct 6a and 6b. The air flow control device 4 may be configured to include at least one valve that opens or closes the first duct 5a and 5b and/or the second duct 6a and 6b under the control command of the controller, and at least one fan that operates to force the air flow along the first duct 5a and 5b and/or the second duct 6a and 6b under the control command of the controller.

Ultimately, the high-temperature air within the slot unit 40 may be applied to the cryptocurrency-mining purpose battery 21 within the storage space 3, thereby increasing the charging efficiency of the battery. In conjunction with this increase, the low-temperature air (especially in winter) in the storage space 3 may be applied to the slot unit 40 to cool the graphics card that generates the heat, thereby preventing performance degradation of the graphics card.

The preferred embodiment of the present disclosure has been described in detail with reference to the drawings. The description of the present disclosure is for illustrative purposes, and a person with ordinary knowledge in the technical field to which the present disclosure belongs may understand that the embodiment may be easily modified into another specific form without changing the technical idea or essential features of the present disclosure.

Therefore, the scope of the present disclosure is indicated by the patent claims described later rather than the detailed description above, and all changes or modified forms derived from the meaning and scope of and equivalent concept to the claims should be interpreted as being included in the scope of the present disclosure.

What is claimed is:

1. A cryptocurrency mining system for an electric vehicle comprising:
a vehicle-driving purpose battery configured to store therein power for driving an electric vehicle;
a motor configured to rotate wheels of the vehicle using power stored in the vehicle-driving purpose battery;
an electric generator configured to generate power using a rotational force of the wheels;
a cryptocurrency-mining purpose battery configured to store therein the power generated by the electric generator; and
a cryptocurrency mining device configured to mine cryptocurrency using the power stored in the cryptocurrency-mining purpose battery.

2. The cryptocurrency mining system for the electric vehicle of claim 1, wherein the cryptocurrency mining system further comprises:
a first inverter configured to convert direct current power of the vehicle-driving purpose battery into alternating current power to be supplied to the motor; and
a second inverter configured to convert direct current power of the cryptocurrency-mining purpose battery into alternating current power to be supplied to the cryptocurrency mining device.

3. The cryptocurrency mining system for the electric vehicle of claim 1, wherein the electric generator is removed from or coupled to a drive shaft of the wheel,
wherein the cryptocurrency mining system for the electric vehicle further comprises a controller configured to generate a control command to remove or couple the electric generator from or to the drive shaft, based on a rotation speed of the wheel or the drive shaft,
wherein the controller is configured to remove the electric generator from the drive shaft when the electric vehicle is not traveling.

4. The cryptocurrency mining system for the electric vehicle of claim 3, wherein the cryptocurrency mining system for the electric vehicle further comprises:
a rectifier provided between and connected to the vehicle-driving purpose battery and the cryptocurrency-mining purpose battery, and configured to rectify a direction of current flow therebetween; and
a switch provided between and connected to the vehicle-driving purpose battery and the cryptocurrency-mining purpose battery, and configured to control an electrical connection therebetween based on a control command from the controller.

5. The cryptocurrency mining system for the electric vehicle of claim 4, wherein the controller is further configured to:
when a remaining stored power amount of the cryptocurrency-mining purpose battery is smaller than or equal to a preset threshold and a remaining stored power amount of the vehicle-driving purpose battery is greater than or equal to a preset lower limit when the cryptocurrency mining device starts to operate or is operating,
close the switch to charge the cryptocurrency-mining purpose battery with the power from the vehicle-driving purpose battery in response to a user input or a preset value.

6. The cryptocurrency mining system for the electric vehicle of claim 3, wherein the cryptocurrency mining system for the electric vehicle further comprises:
a slot unit defined in the vehicle and having a predetermined space;
a slot door provided at an outer surface of the electric vehicle to close or open the slot unit; and
at least one slot located in the slot unit, and connected to the cryptocurrency mining device, wherein a graphics card is removably mounted into the slot.

7. The cryptocurrency mining system for the electric vehicle of claim 6, wherein the controller is further configured to:
identify a power consumption of each graphics card mounted into each of the at least one slot; and
select and operate the graphics card to be used by the cryptocurrency mining device based on a remaining stored power amount of the cryptocurrency-mining purpose battery.

8. The cryptocurrency mining system for the electric vehicle of claim 7, wherein the controller is further configured to:
when the remaining stored power amount of the cryptocurrency-mining purpose battery is smaller than a total of power consumptions of currently installed graphics cards into the slots,
select and operate a graphics card with a lowest power consumption among the graphics cards respectively installed into the plurality of slots at a highest priority.

9. The cryptocurrency mining system for the electric vehicle of claim 6, wherein the controller is further configured to:
identify a power consumption of each graphics card mounted into each of the at least one slot; and
determine a graphics card with the power consumption of 0 as a faulty graphics card.

10. The cryptocurrency mining system for the electric vehicle of claim 6, wherein the slot door includes a shock-absorbing member protruding from an inner surface thereof toward the slot,
wherein when the slot door is closed, the shock-absorbing member presses the graphics card mounted into the slot to prevent the graphics card from being removed from the slot.

11. The cryptocurrency mining system for the electric vehicle of claim 6, wherein the cryptocurrency mining system for the electric vehicle further comprises:
a first temperature sensor for measuring a temperature within the slot unit;
a second temperature sensor for measuring a temperature within a cryptocurrency-mining purpose battery storage space in which the cryptocurrency-mining purpose battery is received;
a first duct constructed to direct heat generated from the graphics card to the cryptocurrency-mining purpose battery storage space; and
a second duct constructed to direct air within the cryptocurrency-mining purpose battery storage space to the slot unit,
wherein the controller is further configured to:
when a temperature measured by the first temperature sensor is higher than a preset first threshold temperature, and a temperature measured by the second temperature sensor is lower than a preset second threshold temperature,
direct the air in the slot unit to the cryptocurrency-mining purpose battery storage space through the first duct, and direct the air in the cryptocurrency-mining purpose battery storage space to the slot unit through the second duct.
